(19) United States
(12) Patent Application Publication
(10) Pub. No.: US 2005/0076140 A1
(43) Pub. Date: Apr. 7, 2005

(54) [TOPOLOGY LOOP DETECTION MECHANISM]

(76) Inventor: HEI TAO FUNG, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,344

(22) Filed: Sep. 24, 2003

(51) Int. Cl. G06F 15/16

(52) U.S. Cl. 709/245

(57) ABSTRACT

Broadcast storm due to topology loop may result from end-user mis-configurations, faulty ports, cabling problems, faulty spanning-tree algorithm implementations, and others. This loop detection mechanism helps detecting topology loops and eliminates them. It operates as a watchdog independent of the spanning-tree algorithm. The feature is aiming at enhancing the values of SO-LOS.

### BACKGROUND OF INVENTION

1. Field of the Invention

The present invention relates to mechanism of detecting topology loop in a network. More particularly, the present invention relates to detecting topology loop independently of other devices in a network.

2. Description of Related Art

Broadcast storm is a non-stop circulation of broadcast packets, and multicast packets as well, by interconnected Local Area Network (LAN) switches. The circulation is due to the presence of network topology loop, which is the presence of forwarding redundant paths, and due to the nature of LAN switching in forwarding received broadcast packets without considering the ‘age’ of the packets. Broadcast storm is evil in that it consumes the network bandwidth uselessly and may cause some hosts busy handling the replicated traffic. Thus a loop detection scheme is needed for eliminating broadcast storm in a LAN switching system. The switch running the loop detection should forward the frame to CPU to analyze the frame for loop detection if it originates the frame—that is accomplished using programmed entries in the switch's L2 forwarding table: directing frames destined to the originator-identifiable MAC address (such as the switch MAC with I/G set) to the CPU.”

One of loop detection schemes is the Spanning-Tree Protocol (STP), which is meant to derive a loop-free network topology. Normally STP in enabled. However, network topology loop can still result in some circumstances such as the following: 1. The STP implementations may be faulty and sometimes fail to derive a loop-free topology. 2. The port hardware may be faulty in such a way that it does not respond correctly to actions from STP. 3. STP may be disabled, intentionally or unintentionally, on the local switch or on the remote switches, or on some ports. End-users may then mistakenly operate the switches without verifying that the topology is loop-free. 4. The port hardware may be faulty in such a way that either the transmission or the reception of packets fails, resulting in unidirectional traffic. Also, a partially broken fiber can result in unidirectional traffic. In that case, STP may innocently move a blocking port to forwarding because the port (or its peer port) does not receive a superior Bridge Protocol Data Unit (BPDU). 5. The IEEE Standard 802.3ad Link Aggregation implementations maybe faulty and frames originated from a link aggregate are forwarded back to the link aggregate. 6. There may be link aggregation mis-configuration. Two sides of the links aggregate the ports differently. 7. Virtual Local Area Network (VLAN) translation may be enabled, intentionally or unintentionally, on the remote switches. End-users may then mistakenly operate the switches without verifying that the topology is loop-free. 8. Bridging between Layer 3 (L3) interfaces is enabled, but the resulting topology is not loop-free.

### SUMMARY OF INVENTION

Accordingly, the invention provides a method of loop detection mechanism where a special multicast frame is sent out on forwarding ports and observed whether the frame will be received on a forwarding port. If there is no topology loop, the frame will be dropped at blocking ports on some remote switches or a local switch. If there is a topology loop, the frame will be received on a forwarding port on the local switch. The local switch is programmed to capture the frame to the CPU for further analysis without further forwarding the frame.

One object of this present invention is to operate a loop detection mechanism outside the Spanning Tree Protocol (STP) mechanism.

Another object of this present invention is to detect loops in the scenarios that STP is not capable of, such as unidirectional links.

Yet another object of this present invention is to consume network bandwidth on an efficient basis, or else the mechanism itself being an evil therein.

Yet another object of this present invention is to conservatively make assumptions about remote (or peer) switches, whether they are running network OS running loop detection, and capabilities and configurations thereof.

Yet another object of this present invention is to operate below the link aggregation layer.

As embodied and broadly described herein, the invention provides a loop detection mechanism to guard against the topology loop. Based on the above description, the mechanism of this present invention possesses the following qualities to provide broadcast storm free network: 1. Operating outside the STP mechanism. 2. Detecting loops in the scenarios that even the STP cannot work, such as unidirectional links. 3. Consuming relatively little network bandwidth, or else itself will be an evil. 4. Not making assumptions about remote (or peer) switches, whether they are running network OS running loop detection, their capabilities, and their configurations. 5. Operating below the link aggregation layer.

The present invention includes phases described thereafter to achieve the above targets and to implement the objects of the loop detection mechanism.

These and other objects, features and advantages of the present invention will become apparent from the following detailed description of illustrative embodiments thereof, which is to be read in connection with the accompanying drawings.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a table depicting loop detection frame format according to one preferred embodiment of this invention.

FIG. 2 is a table depicting loop detection configuration commands according to one preferred embodiment of this invention.

FIG. 3 is a table depicting display loop detection settings according to one preferred embodiment of this invention.

FIG. 4 is a block diagram illustrating topology loop caused by unidirectional link according to one preferred embodiment of this invention.

FIG. 5 is a block diagram illustrating a remote topology loop according to one preferred embodiment of this invention.

FIG. 6 is a block diagram illustrating a STP related topology loop according to one preferred embodiment of this invention.

FIG. 7 is a bock diagram illustrating a topology loop due to link aggregation mis-configuration according to one preferred embodiment of this invention.

FIG. 8 is a block diagram illustrating a topology loop due to VLAN translation according to one preferred embodiment of this invention.

FIG. 9 is a block diagram illustrating a topology loop due to bridging among L3 interfaces according to one preferred embodiment of this invention.

FIG. 10 is a table depicting a Terminator type of type-length-value (TLV) fields according to one preferred embodiment of this invention.

FIG. 11 is a table depicting a Port Identifier type of TLV fields according to one preferred embodiment of this invention.

FIG. 12 is a table depicting a VLAN Identifier type of TLV fields according to one preferred embodiment of this invention.

FIG. 13 is a table depicting a Switch Identifier type of TLV fields according to one preferred embodiment of this invention.

FIG. 14 is a table depicting a Timestamp type of TLV fields according to one preferred embodiment of this invention.

FIG. 15 is a table depicting a Checksum type of TLV fields according to one preferred embodiment of this invention.

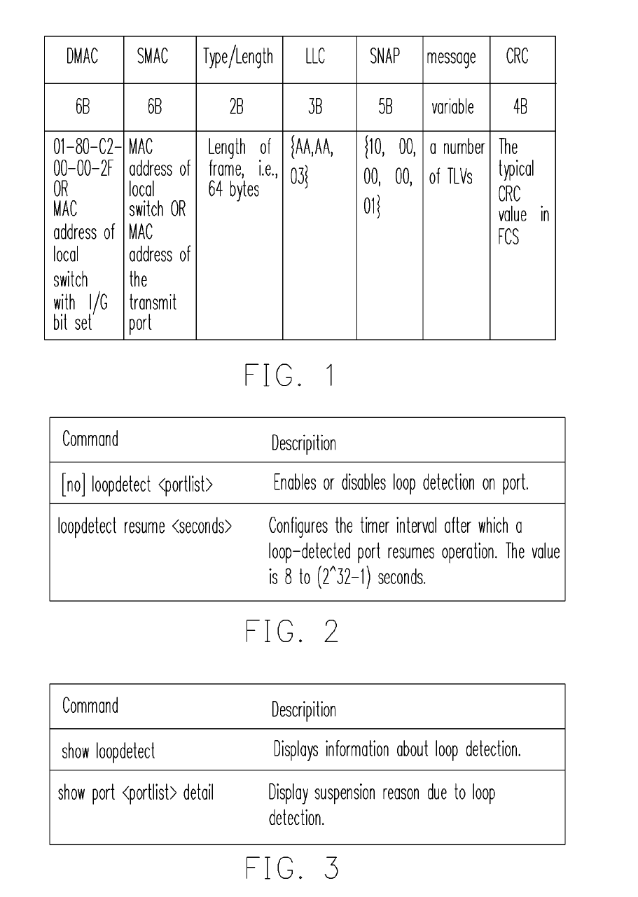

### DETAILED DESCRIPTION

The present invention firstly provides a basic idea of a loop detection mechanism sending a special multicast frame out on the forwarding ports and observing whether the frame will be received on a forwarding port. If there is no topology loop, the frame will be dropped at the blocking ports on some remote switches or the local switch. If there is topology loop, the frame will be received on a forwarding port on the local switch. The local switch is programmed to capture the frame to the CPU for further analysis without further forwarding the frame. In order to demonstrate one preferred embodiment of this present invention, definitions for this loop detection mechanism of the present invention are described in following phases, including frame format, transmission, reception and forwarding, analysis, actions, detection scenarios. Some other considerations and command line interface are described thereafter.

FRAME FORMAT: The loop detection frame has a frame format as listed in the table of FIG. 1. The Destination Media Access Control (DMAC) address can be either 01-80-c2-00-00-2f or the local switch's MAC address with the I/G bit set, for example. On the other hand, the MAC address 01-80-c2-00-00-2f is one of the GARP reserved MAC addresses. Currently such exemplary address has not been used in any standard protocol, thus is valid for this present invention. Firstly, it makes the frame a multicast one, so remote switches not caring about our loop detection will simply broadcast the frame (IEEE Standards Sec. 12.5 02.1D 1998 Edition), and the frame can reach the local switch when there is a topology loop. Secondly, the local can give higher priority (as that of BPDU's) to frames with this MAC address, increasing the likelihood that it can be received and processed by the CPU in case of topology loop and broadcast storm. Using this MAC address can cause a burdened CPU with frame processing because frames with this MAC address will all go through blocking ports as BPDUs. Therefore, using this MAC address is preferred when only a small number, preferable one, of switches are enabled with loop detection.

Another choice for the destination MAC address for one preferred embodiment is the local switch's MAC address with the I/G bit set. The MAC address used as part of the bridge ID in STP can be used here. Then, such a unique destination MAC address can allow the switch originating the frame to capture the frame specifically. The I/G bit is turned on so that the frame is a multicast one for the same reason as discussed previously. Using such MAC addresses possesses no priority treatment for the frames, and the frames are more likely (than using 01-80-c2-00-00-2f, which can let the frames be treated as PDUs with treatment or priority similar to BPDUs) to be dropped in broadcast storm. Yet the software does not need to be involved in processing the received frames unless they are destined to the local switch's MAC address with the I/G bit set. This property keeps the CPU load low even when a large number of switches are enabled with loop detection. The local switch's MAC address with the I/G bit set can be used as the destination MAC address in one preferred embodiment of this present invention.

The source MAC address of the frame can be the local switch's MAC address(with I/G bit cleared). The MAC address used as part of the bridge ID in STP can be used here, or it can be the MAC address associated with some L3 interfaces (VLAN interfaces). Notice that remote switches will learn about this MAC address in their forwarding tables. Alternatively, the source MAC address of the frame can be the transmitting port's MAC address Using that can help identify the port originating a frame.

The message field herein consists of a number of Type-Length-Value (TLV) fields. The type sub-field represents the length of values (in units of bytes) to be followed. The value sub-field is optional, and when presents, carries the values of the TLV field. The choice of the DMAC is critical in that it must be a multicast address (I/G set) and allow the originator to capture the frame easily. The choice in this preferred embodiment is the switch MAC with I/G set because the switch MAC can uniquely identify the originator. The capture mechanism is through programming the L2 forwarding table with an entry directing the frame destined to the MAC address to CPU.

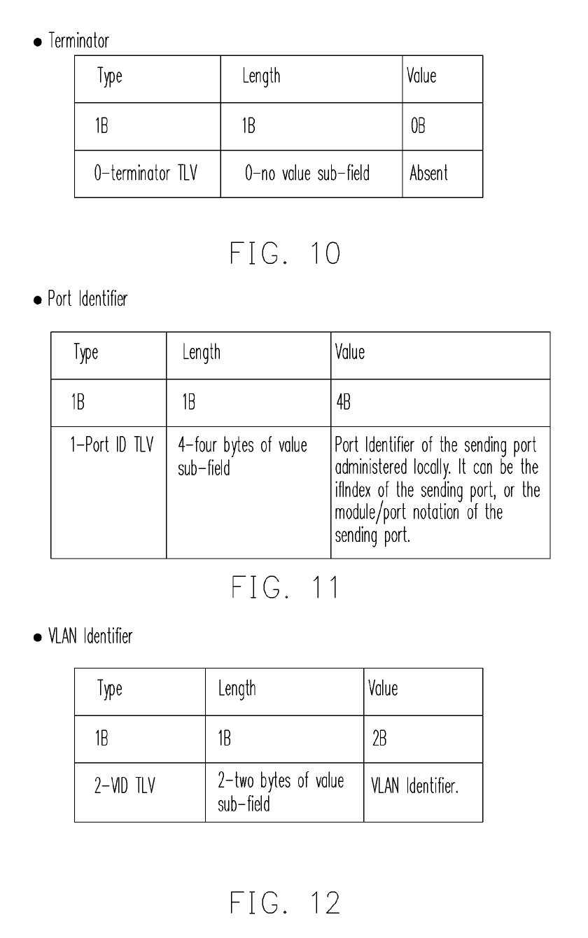

Referring to FIGS. 10 to 15, TLVS and the sub-fields thereof are described hereafter.

Referring to FIG. 10 wherein a terminator is described, the TLV is mandatory according to one preferred embodiment of the present invention. It is used to signify the end of message and extend the frame to a particular size and byte alignment.

Referring to FIG. 11 wherein a port identifier is described, the TLV is optional but recommended according to one preferred embodiment of the present invention. There is no other information besides the source MAC address of the received frame to derive the port originating the frame. Sometimes the Ethernet frame header may not be available to the loop detection mechanism. Knowing the port originating the frame is crucial in determining whether the local switch is part of the topology loop or the loop resides remotely.

Referring to FIG. 12 wherein a VLAN identifier is described, the TLV is mandatory according to one preferred embodiment of the present invention. It is used when the originating VLAN cannot be identified because the VLAN tag or its derived information is not available to the loop detection software module. Even when the VLAN information is available, it may not be trustworthy due to the potential VLAN translation on remote switches.

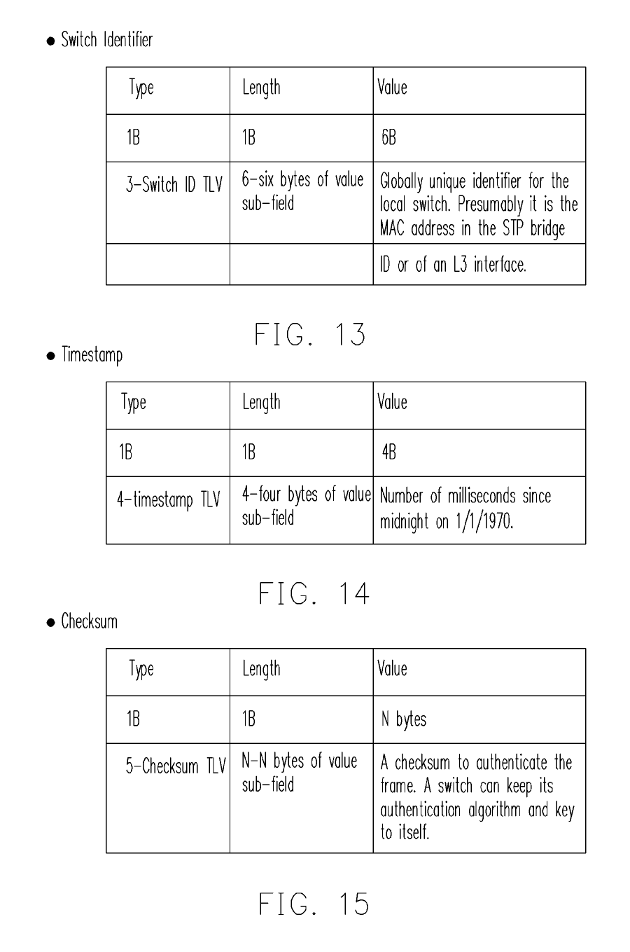

Referring to FIG. 13 wherein a switch identifier is described, this TLV is optional according to one preferred embodiment of the present invention. It is useful when the frames' originator cannot be identified from the destination MAC address or the source MAC address. That may be the case when the Ethernet frame header or its derived information is not available to the loop detection software module.

Referring to FIG. 14 where a timestamp is described, the time stamp TLV is optional according to one preferred embodiment of the present invention. It can help identify how long the frame has lingered. It carries the number of milliseconds after the “Epoch Time” based on the local switch's clock. The loop detection mechanism can ignore frames that have lingered for too long, which can be caused by a non-dying loop. It can prevent replay attack whereby a malicious entity retransmits a valid but old frame to cause a false detection. It is recommended that the frames older than the maximum frame lifetime should be ignored. The maximum frame lifetime is equal to the maximum bridge transit delay (4 seconds) times the maximum bridge diameter (7 bridges) plus the maximum medium access delay for the initial transmission (Sec B.3.1.2 in 802.1D). The recommended value is 7.5 seconds and should not exceed 30 seconds, for example.

Referring to FIG. 15 where a checksum is described, the checksum TLV is mandatory according to one preferred embodiment of the present invention. It can help authenticate the frame and prevent maliciously faked loop detection frame from interfering with the network. The checksum algorithm and the key to the algorithm can vary from switch to switch. For example, a 16-byte MD5 checksum is calculated from a random key generated by the loop detection software and the whole Ethernet frame except the CRC with the checksum TLV value field zeroed out. The random key can be changed from time to time to guard against replay attack of sending the same frame that has caused a loop-detection positive. If the received frame fails the checksum verification, the frame is considered invalid.

TRANSMISSION: A transmission introduced in the present invention is described herein. The loop detection frames are sent out on forwarding port on assigned VLANs. Whereas they can be sent out on non-forwarding ports also.

Topology loop is tested on a per-VLAN basis. Though the STP calculated topology for the VLANs of the same STP instance should be the same, it is desirable to test for topology loop for each active VALN. One reason is that the allowed VLANs may vary from port to port. Another reason is that the STP state in hardware is likely to be per-port-per-VLAN.

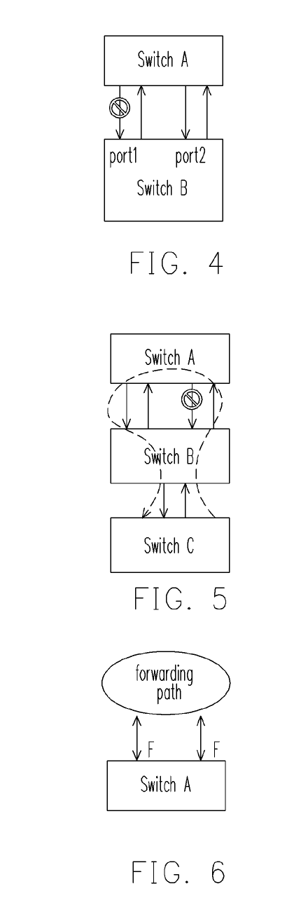

It is desirable that sending the loop detection frames out one port belonging to the VLAN under test is sufficient in detecting topology loop on the VLAN. However, some topology loop is caused by unidirectional link, and sending loop detection frames out always on one port may fail to detect that. For example, referring to FIG. 4, Switch A and Switch B are connected by two links. Switch A is supposed to be the STP root bridge, but its BPDU fails to reach Switch B on port 1 due to unidirectional link. That results in both links in forwarding states. Suppose that only Switch B is running loop detection. If the loop detection frames are sent out only on port 2, they will not reach Switch A again. Therefore, loop detection frames should be sent out on all forwarding ports on the switch running loop detection.

On the other hand, it is desirable to limit the load on the network and the CPU by limiting the number of the frames sent out. The requirements of slow protocol transmission characteristics described in Annex 43B of IEEE 802.3ad, 2000 specifies that the maximum traffic loading is limited to 50 frames per second per port. Using that as a reference, the first transmission algorithm can be as follows: i. On every second, all ports of the local Switch Are candidates for loop detection frame transmission. ii. On each port, send one loop detection frame on the VLANs under test, which are in forwarding states, for up to 50 such VLANs. Treat all VLANs fairly. For example, use a last-VID-used variable on each port. Send frames on VLANs from last-VID-used on. Then update the variable after transmission. When the variable reaches 4096, set it back to 1.

The above algorithm emphasizes the balance between fast detection, non-excessive load, and fairness to all VLANs or all ports. However, it may not be optimal for implementation because some ASIC switch engines can send to all ports on the same VLAN in one operation. The second transmission algorithm is as follows: i. On every second, all active VLANs of the local Switch Are candidates for loop detection transmission. ii. On each VALN, send one loop detection frame on all ports in the active topology of the VLAN. Do that for up to 50 VLANs. Use a global last-VID-used variable to help rotating through all active VLANs.

This algorithm may result in some ports not sending any loop detection frame for some time. The worst case is about 80 (4096/50) seconds. However, in practice there are a small number (likely to be fewer than 50) of active VLANs on the switch.

RECEPTION AND FORWARDING: When a conventional switch or a switch in the present invention with loop detection disabled receives a loop detection frame on a port on the active topology, it should forward the frame unmodified to all other ports on the active topology.

When a conventional switch with loop detection enabled receives a loop detection frame on a port on the active topology (a forwarding port), the switch should forward the frame unmodified to all other ports on the active topology if it does not originate the frame. The switch should forward the frame to CPU to analyze the frame for loop detection if it originates the frame. When the switch receives a loop detection frame on a blocking port, it may discard the frame and should not forward the frame further.

When the switch receives a loop detection frame on a port on the active topology, but the frames' assigned VID is different from the originating VID, the switch should forward the frame unmodified to all other ports on the active topology of the assigned VID. Receiving such a loop detection frame has not proven the existence of topology loop. Forwarding the frame on the assigned VID can further explore the possibility of topology loop. This forwarding rule is considered optional, but without it some loops cannot be detected, which is described afterwards in detection phase.

ANALYSIS: A switch with loop-detection enabled should perform loop detection analysis on a frame on a port on the active topology originated from the switch itself. In that case, it is likely that there is or was a topology loop.

To be conservative (reducing false positives), the loop detection software module should check the ports states again. If the port originating the frame and the port receiving the frame are both in forwarding state, then there is a topology loop. If both ports are in fact two different ports, then the local switch is part of the topology loop (such as illustrated in FIG. 4). If both ports are in fact the same port, then the topology loop resides remotely (such as illustrated in FIG. 5).

For example, referring to FIG. 5 herein. There is a topology loop between Switch A and Switch B, but there is only a link between C and Switch B. Suppose that Switch C is enabled with loop detection. Loop detection frame sent out on Switch C will be received on the same port.

ACTIONS: Once a topology loop is detected, end-users should be notified to remedy the situation. If possible the switch should automatically stop the loop.

When the detecting switch is part of the topology loop, it can stop the loop by suspending the port to take it out of STP's control and setting the port state to blocking. There are two choices of which port to block: the port originating the frame, and the port receiving the frame. The former shall be blocked because that could be the source of the problem in the unidirectional link case. For example, in FIG. 4, it is better that Switch B clocks port 1 instead of port 2. A blocked port due to loop detection can resume operation automatically after a timer expiry, say 3 minutes, so that end-users do not need to access the switch to do that.

When a switch detects a remote loop, the switch cannot stop the loop. The switch should alarm the end-users to implement the remedy. The loop detection frame that triggers the detection may be replicated many times by the loop. The switch should block these frames from burdening the CPU. Such block can be removed after a timer expiry, e.g. 3 minutes, so that end-users can be warned again if the loop persists.

Ideally, a remote loop can be stopped soon and automatically. However, the remote switches causing the loop cannot be identified in the loop detection frame. It is noted that the loop detection mechanism is designed not to rely on the cooperation of remote switches. Other mechanisms outside the scope of this loop detection mechanism can be used to stop a remote loop.

DETECTION SCENARIOS: There are various reasons that result in topology loops. Some scenarios detectable by loop detection mechanism are illustrated herein. It is to be noted that these scenarios are by no means exhaustive, which are described hereafter in at least five phases.

i. STP Related Problems: A topology loop forms when a switch opens up a supposedly blocking port to forwarding. That can be caused by faulty STP implementation and by port hardware not reacting properly to STP control. This can be due to the port is configured to be forwarding (e.g., STP is disabled on the port, or port copy feature is turned on.) while it is not supposed to.

ii. Unidirectional Link: Unidirectional links may be caused by port hardware stuck at the transmission logic or at the receiving logic. They may also be caused by partially broken fiber. Referring to FIG. 4, when there is a unidirectional link, one side of the link will not receive any BPDU, hence moving to forwarding state. When this side would have been blocking if the BPDUs have been received, a loop is formed.

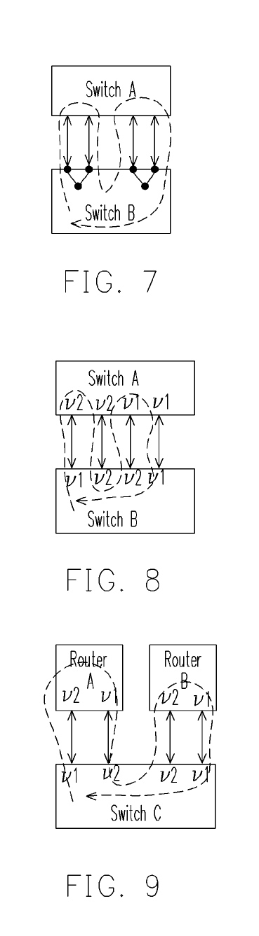

iii. Link Aggregation Related Problems: Topology loops may be formed when two sides of the links have different link aggregation configurations. Referring to FIG. 7 as an example, Switch A and Switch B are connected through two links and all ports are somehow in forwarding state. On Switch B, links are aggregated and treated as two logical ports. On Switch A, links are treated as individual ports. When a broadcast frame is sent from Switch B, Switch A will forward the frame to Switch B via the other link.

iv. VLAN Translation: VLAN translation when not used carefully can lead to topology loop. Referring to FIG. 8 as an example, Switch A and Switch B are connected through four links and all ports are somehow in forwarding state, but the VLAN assignments on the ports can be inconsistent, causing broadcast frames to be looped between Switch A and Switch B. In this example, it is observed that Switch B receive its loop detection frame originated on VLAN 1 two times, first on VLAN 2 and second on VLAN 1. It is therefore paramount that Switch B should forward the loop detection frame when it is first received on VLAN 2. At the second time Switch B receives the same loop detection frame on VLAN 1, now the originating VLAN in the loop detection frame is the same as the assigned VLAN, proving that there is a topology loop.

v. Bridging among L3 Interfaces: Some routers allow bridging of frames among L3 interfaces. Such kind of bridging can change the assigned VLAN of the bridged frames. Topology loop is also possible. Referring to FIG. 9 as an example, router A and router B are enabled with bridging between VLAN 1 and VLAN 2 interfaces. Broadcast frames are looped through Switch C, Router A, and Router B. In this example, it is observed that Switch C may receive its loop detection frame originated on VLAN 1 two times, first on VALN 2 and second on VLAN 1. It is therefore paramount that Switch C should forward the loop detection frame when it is first received on VLAN 2. At the second time Switch C receives the same loop detection frame on VLAN 1, now the originating VLAN in the loop detection frame is the same as the assigned VLAN, proving that there is a topology loop.

Other Considerations

Deployment: Just for the sake of detecting topology loops, enabling loop detection on one switch is sufficient. However, a detecting switch cannot stop a remote loop. To have the capability in stopping all detected loops, enable loop detection on all switches.

Because of that remote loops cannot be stopped by a local switch, it is imperative to choose a well-located switch to run loop detection if it is to run on only one switch. A well-located switch can be one where there is potentially a topology loop. Such a switch is usually located in the distribution layer.

Normally the uplink ports of an access layer switch lead to the distribution layer switch. Loop detection can be more helpful on the uplink ports than on the edge ports if enabling on all ports is a concern.

CPU load: It may seem preferable to run loop detection on all switches, assuming they support loop detection. In that case, using 01-80-c2-00-00-2f as the destination MAC address of loop detection frames can lead to excessive load on the CPU. It would be more desirable to use the switch MAC address with I/G bit set as the destination MAC address. Some ASIC switch engines can still prioritize the generation of the loop detection frames destined to the switch MAC address, and if there is a topology loop, the frames will be replicated many times. Therefore the likelihood of receiving the loop detection frames and detecting the topology loop may not be significantly less than using 01-80-c2-00-00-2f as the destination MAC address.

Detecting Capability: The loop detection does not guarantee detecting all topology loops though for now all perceivable cases seem covered.

However sound the mechanism it seems, it is still possible that the loop detection frames fail to reach the originating switch due to various reasons. For example, they can be dropped by broadcast suppression.

If the second loop detection frame transmission algorithm is used, a switch is likely to detect a loop between 1 to 80 seconds.

It will be apparent to those skilled in the art that various modifications and variations can be made to the structure of the present invention without departing from the scope or spirit of the invention. IN view of the foregoing, it is intended that the present invention covers modifications and variations of this invention provided they fall within the scope of the following claims and their equivalents.

1. A topology loop detection mechanism, for a network, comprising:
sending out a loop detection frame; and
detecting a topology loop.

2. The topology loop detection mechanism as recited in claim 1, wherein the loop detection frame comprises a plurality of fields, the fields at least comprising:
a Destination Media Access Control (DMAC) address; and
a Source Media Access Control (SMAC) address.

3. The topology loop detection mechanism as recited in claim 2, wherein the DMAC address is 01-80-c2-00-00-2f.

4. The topology loop detection mechanism as recited in claim 2, wherein the DMAC address is a Media Access Control (MAC) address of a local switch with an I/G bit set.

5. The topology loop detection mechanism as recited in claim 2, wherein the SMAC address is the MAC address of a local switch with the I/G bit cleared.

6. The topology loop detection mechanism as recited in claim 2, wherein the loop detection frame further comprises a type/length, which carries a length of the loop detection frame.

7. The topology loop detection mechanism as recited in claim 2, wherein the loop detection frame further comprises a SNAP.

8. The topology loop detection mechanism as recited in claim 2, wherein the loop detection frame further comprises a message, including a plurality of Type-Length-Value (TLV) fields.

9. The topology loop detection mechanism as recited in claim 8, wherein the loop detection frame further comprises a TLV field, which including:
a terminator, for signifying an end of a message and extend the loop detection frame to particular size and byte alignment;
a port identifier, for determining whether the local switch is part of the topology loop or the topology loop resides remotely;
a VLAN identifier, for the loop detection frames” originator not being identified because the VLAN or its derived information is not available to a loop detection software module;
a switch identifier, for the loop detection frames” originator not being identified from the DMAC address or the SMAC address;
a timestamp, for identifying how long the loop detection frame has lingered, being against a replay attack; and
a checksum, for authenticating the loop detection frame, being against a faked loop detection frame from interfering with the network.

10. The topology loop detection mechanism as recited in claim 1, wherein the detecting of the topology loop comprises:
a transmission procedure;
a reception and forwarding procedure;
an analysis procedure; and
an action procedure.

11. The topology loop detection mechanism as recited in claim 10, wherein the transmission procedure comprising:
a first transmission algorithm, emphasizing the balance between fast detection, non-excessive load, and fairness to all the VLANs or a plurality of ports, comprising:
all the ports of the local switch being candidates for the transmission of the loop detection frame on every second, and
sending out the loop detection frame on the VLANs under test on each the port, which are in a forwarding states for up to fifty such the VLANs which are treated fairly; and
a second transmission algorithm, comprising:
all the VLANs of the local switch in action being candidates for loop detection transmission on every second, and
sending one the loop detection frame on all the ports in an topology in action of the VLAN up to fifty the VLANs on each of the VLANs.

12. The topology loop detection mechanism as recited in claim 11, wherein the second transmission algorithm requires a detecting time of the topology loop between 1 to 80 seconds.

13. The topology loop detection mechanism as recited in claim 10, wherein the reception and forwarding procedure comprise:
receiving the loop detection frame on a forwarding port on the topology in action,
the local switch forwarding the loop detection frame unmodified to all other the ports on the topology in active if not originating the frame, and
discarding the loop detection frame and ought not forward the loop detection frame further when the local switch receiving the loop detection frame on a blocking port.

14. The topology loop detection mechanism as recited in claim 10, wherein the analysis procedure comprises:
determining the topology loop if the port originating the loop detection frame and the port receiving the loop detection frame are both in forwarding states;
the local switch being part of the topology loop if the ports being in different the ports; and
the topology loop residing remotely if the ports being the same port.

15. The topology loop detection mechanism as recited in claim 10, wherein the action procedure for stopping the topology loop if detected comprising:
blocking the port originating the loop detection frame if a unidirectional link occurs;
alarming the end-user to implement a remedy if detecting a remote topology loop; and
resuming operation automatically after a timer expiry.

16. The topology loop detection mechanism as recited in claim 15, wherein the blocked port due to loop detection resumes operation automatically after the timer expiry, so that end-users do not need to access the switch to do that

17. The topology loop detection mechanism as recited in claim 1, wherein the topology loop is detected upon detecting a STP related problem, wherein the topology loop forms when the local switch opens up the blocking port to the forwarding port by mistake.

18. The topology loop detection mechanism as recited in claim 1, wherein the topology loop is detected upon detecting a unidirectional link, wherein port hardware is stuck at a transmission logic or at a receiving logic.

19. The topology loop detection mechanism as recited in claim 1, wherein the topology loop is detected upon detecting a link aggregation, wherein two sides of links have different the link aggregations.

20. The topology loop detection mechanism as recited in claim 1, wherein the topology loop is detected upon detecting VLAN translation, wherein assignments to VLAN on the ports are inconsistent.

21. The topology loop detection mechanism as recited in claim 1, wherein the topology loop is detected upon detecting bridging among a plurality of L3 interfaces, wherein a router allows bridging of the loop detection frame among the L3 interfaces that changes the assigned VLAN of the bridged loop detection frames.

22. The topology loop detection mechanism as recited in claim 1, wherein the detecting the topology loop is done by enabling the local switch that is located where the topology loop potentially exists.

23. The topology loop detection mechanism as recited in claim 1, wherein the local switch MAC address with the I/G bit is set as the DMAC address for reducing CPU load.

24. The topology loop detection mechanism as recited in claim 1, wherein the port is disabled by default, the port featuring disabled receives or forwards the loop detection frames, and the port featuring enabled sends out the loop detection frames and is blocked when the topology loop is detected.

25. The topology loop detection mechanism as recited in claim 1, wherein the topology loop detection mechanism is independent of a switch”s capa'ility of detecting a topology loop.

26. The topology loop detection mechanism as recited in claim 1, wherein the topology loop detection mechanism allows any checksum/authentication algorithm.
